(19) United States
(12) Patent Application Publication
(10) Pub. No.: US 2025/0214564 A1
(43) Pub. Date: Jul. 3, 2025

(54) MULTI-OBJECTIVE OPTIMIZATION METHOD AND SYSTEM ASSISTED BY GRADIENT BOOSTED NEURAL NETWORK AND DEVICE

(71) Applicant: XIANGTAN UNIVERSITY, Hunan (CN)

(72) Inventors: Juan ZOU, Hunan (CN); Zhanglu HOU, Hunan (CN); Yuan LIU, Hunan (CN); Yizhang XIA, Hunan (CN); Yang LIU, Hunan (CN)

(21) Appl. No.: 18/985,734

(22) Filed: Dec. 18, 2024

Related U.S. Application Data
(63) Continuation-in-part of application No. PCT/CN2024/072216, filed on Jan. 15, 2024.

(30) Foreign Application Priority Data
Jun. 12, 2023 (CN) 202310691691.3

(51) Int. Cl. B60W 20/15; B60W 10/06; B60W 50/00; G05B 13/02

(52) U.S. Cl. CPC B60W 20/15; B60W 10/06; B60W 50/00; G05B 13/027; B60W 2050/0028; B60W 2510/0638; B60W 2510/0657; B60W 2510/244; B60W 2530/209; B60W 2710/06

(57) ABSTRACT

Provided are a multi-objective optimization method and system assisted by a gradient boosted neural network, and a device, relating to the technical field of objective optimization. The method includes: obtaining sample data of an energy control management system of a hybrid electric vehicle through design of experiments; determining an approximate function for a multi-objective optimization problem of the energy control management system based on a gradient boosted neural network algorithm; and solving the approximate function by using a multi-objective optimization algorithm to obtain an optimal solution. The present application can solve issues such as time-consuming function evaluation and inability to obtain an optimal solution of the problem.

### CROSS REFERENCE TO RELATED APPLICATION

The present disclosure is a continuation-in-part of International Patent Application No. PCT/CN2024/072216, filed on Jan. 15, 2024, which claims priority to the Chinese Patent Application No. 202310691691.3 filed with the China National Intellectual Property Administration on Jun. 12, 2023, and entitled “MULTI-OBJECTIVE OPTIMIZATION METHOD AND SYSTEM ASSISTED BY GRADIENT BOOSTED NEURAL NETWORK, AND DEVICE”, which is incorporated herein by reference in its entirety.

### TECHNICAL FIELD

The present disclosure relates to the technical field of objective optimization, and in particular, to a multi-objective optimization method and system assisted by a gradient boosted neural network, and a device.

### BACKGROUND

Hybrid electric vehicles derive power from both an internal combustion engine and an electric motor. In the design of hybrid electric vehicles, the energy control manager plays a crucial role in ensuring hybrid performance.

Typically, the energy control management system of a hybrid electric vehicle, as shown in FIG. 1, mainly includes an internal combustion engine, a power control system, a battery, and an electric motor. Before driving of the hybrid electric vehicle, the battery is charged from the grid. During braking, the electric motor can act as a generator to recover energy generated due to braking back to the battery. The energy control management system uses the battery state at time t, denoted as SOC(t), as input of the energy control management system to determine specific control.

Considering that vehicle speed and torque are controlled by the driver or external devices, it is challenging to quantify the vehicle speed and torque with specific parameters and models. In the design of the energy control management system, it is necessary to consider different objective optimization problems. These problems are black-box optimization problems. Existing modal analysis methods, such as finite element analysis and experimental modal analysis, can approximate real physical models well, but the established models are generally complex, and model evaluation is time-consuming.

To address this issue, the industry has started using machine learning techniques to fit complex physical models. For example, proxy models like binomial approximation and support vector machine models are used to fit complex functions. While these methods partially address the drawbacks of the modal analysis methods, they fail to meet the requirements of fitting complex multi-objective optimization functions, and have limitations in fitting complex physical models.

### SUMMARY

An objective of the present disclosure is to provide a multi-objective optimization method and system assisted by a gradient boosted neural network, and a device, to solve issues such as time-consuming function evaluation and inability to obtain an optimal solution of the problem.

To achieve the above objective, the present disclosure provides the following technical solutions:

According to a first aspect, the present disclosure provides a multi-objective optimization method assisted by a gradient boosted neural network, including:
obtaining sample data of an energy control management system of a hybrid electric vehicle through design of experiments;
determining an approximate function for a multi-objective optimization problem of the energy control management system based on a gradient boosted neural network algorithm; and
solving the approximate function by using a multi-objective optimization algorithm to obtain an optimal solution;
controlling the internal combustion engine according to the optimal solution by an power control system of the energy control management system.

Optionally, the sample data includes at least a maximum threshold range of a battery state of charge when an internal combustion engine is turned off, a minimum threshold range of the battery state of charge when the internal combustion engine is turned on, a minimum speed range for operating the internal combustion engine, a maximum speed range for operating the internal combustion engine, a speed range of the internal combustion engine, a torque value range of the internal combustion engine, and a speed range at which the internal combustion engine is turned off.

Optionally, the optimal solution comprises at least optimal values of a maximum threshold of the battery state of charge when the internal combustion engine is turned off, a minimum threshold of the battery state of charge when the internal combustion engine is turned on, a minimum speed for operating the internal combustion engine, a maximum speed for operating the internal combustion engine, a speed of the internal combustion engine, a torque value of the internal combustion engine, and a speed at which the internal combustion engine is turned off

Optionally, objectives in the multi-objective optimization problem are: battery stress, operation changes, emission, noise, and battery state of charge.

Optionally, said determining the approximate function for the multi-objective optimization problem of the energy control management system based on the gradient boosted neural network algorithm specifically includes:
training the gradient boosted neural network based on the sample data and a Kriging model to obtain the approximate function for the multi-objective optimization problem.
Optionally, said solving the approximate function by using the multi-objective optimization algorithm to obtain the optimal solution specifically includes:

solving the approximate function by using a Non-dominated Sorting Genetic Algorithm II (NSGA-II), to obtain the optimal solution.

According to a second aspect, the present disclosure provides a multi-objective optimization system assisted by a gradient boosted neural network, including:
a data obtaining module configured to obtain sample data of an energy control management system of a hybrid electric vehicle through design of experiments;
an approximate function determining module configured to determine an approximate function for a multi-objective optimization problem of the energy control management system based on a gradient boosted neural network algorithm; and
an optimization solving module configured to solve the approximate function by using a multi-objective optimization algorithm to obtain an optimal solution.

According to a third aspect, the present disclosure provides an electronic device including a memory and a processor, where the memory is configured to store a computer program, and the processor runs the computer program to enable the electronic device to perform the multi-objective optimization method assisted by a gradient boosted neural network as described in the first aspect.

According to specific embodiments provided in the present disclosure, the present disclosure has the following technical effects:

Based on the gradient boosted neural network algorithm, the present disclosure transforms a multi-objective optimization problem of an energy control management system into an approximate function and solves the approximate function based on a multi-objective optimization algorithm, thereby solving issues such as time-consuming function evaluation and inability to obtain an optimal solution of the problem.

### BRIEF DESCRIPTION OF THE DRAWINGS

To describe embodiments of the present disclosure or technical solutions in the prior art more clearly, the accompanying drawings required in the embodiments are briefly introduced below. Obviously, the accompanying drawings described below are only some embodiments of the present disclosure. Those of ordinary skill in the art can also obtain other accompanying drawings according to these accompanying drawings without creative efforts.

FIG. 1 is a schematic structural diagram of an energy control management system of a hybrid electric vehicle according to an embodiment of the present disclosure;

FIG. 2 is a schematic flowchart of a multi-objective optimization method assisted by a gradient boosted neural network according to an embodiment of the present disclosure;

FIG. 3 is an overall block diagram of a multi-objective optimization method assisted by a gradient boosted neural network according to an embodiment of the present disclosure; and

FIG. 4 is a flowchart of implementation of a multi-objective optimization algorithm according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure clearer and more comprehensible, the present disclosure will be further described in detail below with reference to the accompanying drawings and the specific embodiments.

### Embodiment 1

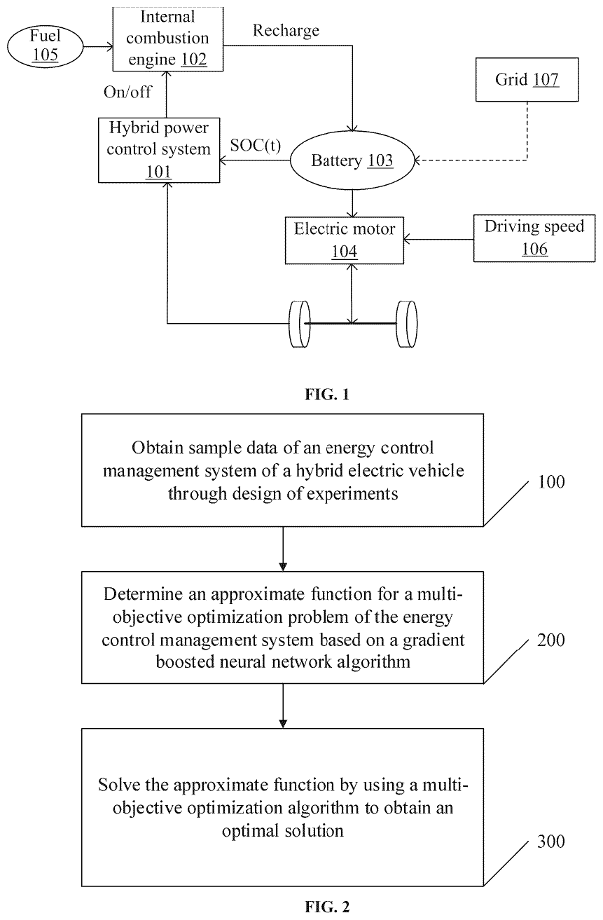

An energy control management system of a hybrid electric vehicle faces complex and expensive multi-objective optimization problems. As shown in FIG. 1, the energy control management system may include a hybrid power control system 101 an internal combustion engine 102, a battery 103, and an electric motor 104. The battery may be electrically connected to the grid 107 for charging. The internal combustion engine consumes fuel 105 to drive the vehicle. During braking, the electric motor 104 can act as a generator to converting the kinetic energy of a vehicle with a driving speed 106 into electrical energy for recovery to the battery. Existing solving methods are often costly. Especially, function evaluation is time-consuming, posing a significant challenge when conventional solvers are used for such problems. The present disclosure introduces a multi-objective optimization method assisted by a gradient boosted neural network, to address issues like time-consuming function evaluation and inability to obtain an optimal solution of the problem in methods such as finite element analysis.

The present disclosure focuses solely on optimizing the control management of the internal combustion engine 102.

The specific multi-objective optimization problem to be solved by the present disclosure is shown in Table 1 and Table 2.

TABLE 1
Specific definitions of parameters in
the energy control management system:

| Design parameters | Range | Physical meaning |
|---|---|---|
| SOCₘₐₓ(%) | [25, 50] | Maximum threshold of the battery |
| | | state of charge when the internal |
| | | combustion engine is turned off |
| SOCₘᵢₙ(%) | [20, 30] | Minimum threshold of the battery |
| | | state of charge when the internal |
| | | combustion engine is turned on |
| V₁(km/h) | [20, 60] | Minimum speed for operating the |
| | | internal combustion engine |
| V₂(km/h) | [50, 100] | Maximum speed for operating the |
| | | internal combustion engine |
| Rev₁(/min) | [2500, 3000] | Speed of the internal combustion |
| | | engine during operation 1 |
| Rev₂(/min) | [3000, 4000] | Speed of the internal combustion |
| | | engine during operation 2 |
| Rev₃(/min) | [4000, 5000] | Speed of the internal combustion |
| | | engine during operation 3 |
| Torque₁(N · m) | [5.23, 12.56] | Torque value of the internal |
| | | combustion engine during |
| | | operation 1 |
| Torque₂(N · m) | [5.56, 12.59] | Torque value of the internal |
| | | combustion engine during |
| | | operation 2 |
| Torque₃(N · m) | [7.77, 23.03] | Torque value of the internal |
| | | combustion engine during |
| | | operation 3 |
| V_{off}(km/h) | [20, 50] | Speed at which the internal |
| | | combustion engine is turned off |

In the above Table 1, the minimum speed (V₁) and the maximum (V₂) for operating the internal combustion engine 102 and the speed (V_{off}) at which the internal combustion engine 102 is turned off represent the vehicle speed, while the speed (Rev₁, Rev₂, Rev₃) of the internal combustion engine 102 represent the revolutions per minute (RPM) of the engine internal combustion engine 102.

Hybrid electric vehicles need to be operated according to specific rules, as outlined below:
Rule 1: Turn off the internal combustion engine 102 if the speed is lower than V_{off}.
Rule 2: Turn off the internal combustion engine 102 if the battery state of charge exceeds SOCₘₐₓ.

SOCₘₐₓ is not the maximum value of the battery state of charge, but merely represents the level of the battery state of charge, and its state value indicates that the battery 103 is no longer charging.
Rule 3: Turn on the internal combustion engine 102 if the battery state of charge is below SOCₘᵢₙ. This rule has a higher priority than rule 1.
Rule 4: Execute operation 1 if the internal combustion engine 102 is on and the speed is lower than V₁.
Rule 5: Execute operation 2 if the internal combustion engine 102 is on and the speed is between V₁ and V₂.
Rule 6: Execute operation 3 if the internal combustion engine 102 is on and the speed is higher than V₂.

Operations 1, 2, and 3 may correspond to the torque values and speeds of the internal combustion engine 102 defined in Table 1.

For example, in operation 1, the internal combustion engine 102 operates in the condition of Rev₁ and Torque₁; in operation 2, the internal combustion engine 102 operates in the condition of Rev₂ and Torque₂; and in operation 3, the internal combustion engine 102 operates in the condition of Rev₃ and Torque₃.

TABLE 2
Specific definitions of objectives in the multi-objective optimization
problem of the energy control management system

| Sequence number | Physical meaning |
|---|---|
| of the objective | of the objective |
| Objective 1 | Battery stress (BS) |
| Objective 2 | Operation changes (OPC) |
| Objective 3 | Emission |
| Objective 4 | Noise |
| Objective 5 | Battery state of charge (SOC) |

To address the complex and expensive multi-objective optimization problems in the energy control management system (also known as the hybrid power system), this present disclosure proposes using a neural network model to fit the function of the multi-objective black-box optimization problem. Due to the difficulty in obtaining gradient information for the problem, the present disclosure utilizes a Kriging model to fit the problem function before using the neural network model, thereby obtaining the gradient information for the problem.

Kriging is a method for predicting a function value at a given point by calculating a weighted average of function values of sample points in the vicinity of that point. This method is closely related to regression analysis in mathematics. Kriging interpolation is a linear unbiased optimal estimation interpolation method that not only fully considers a position relationship between an observation point and an estimation point but also takes into account a spatial relationship between the observation point and the estimation point.

The Kriging model can be expressed in the following form:

$$y ( x ) = F ( β , x ) + z ( x ) = {f}^{T} ( x ) β + z ( x ) .$$

β represents a regression coefficient, f^{T}(x) represents a polynomial regression model, which simulates a global estimation model of a design space and is known as deterministic drift; z(x) represents a random distribution error used to simulate approximate local deviations, and statistical characteristics thereof can be represented by the following formula:

$$E [ z ( x ) ] = 0 , Var [ z ( x ) ] = {δ}^{2} , Cov [ z ( {x}_{i} ) , z ( {x}_{j} ) ] = {σ}^{2} R ( c , {x}_{i} , {x}_{j} ) .$$

R(c, xᵢ, xⱼ) is a correlation coefficient function between any two points with parameter c, representing the correlation between any two points xᵢ and xⱼ. The correlation function relationship is as follows:

$$R ( c , {x}_{i} , {x}_{j} ) = {\prod }_{t = 1}^{n} {R}_{t} ( {θ}_{t} , \vert {x}_{i}^{t} - {x}_{j}^{t} \vert ) = {\prod }_{t = 1}^{n} {R}_{t} ( {θ}_{t} , {d}_{t} ) .$$

n is the number of design variables, x^{t}ᵢ and x^{t}ⱼ are the t-th components of xᵢ and xⱼ, and dₜ is a Euclidean distance between the two points.

In the process of implementing a gradient boosting machine, it is assumed that the prediction function after m iterations is Fm(x) and the corresponding loss function is L(y, Fm(x)). To achieve the fastest reduction of the loss function, a sub-model function of the (m+1)-th iteration is constructed in the direction of gradient descent of the loss function, where the gradient descent direction at this time is:

$$- {g}_{m} ( i ) = - {[ \frac{\partial L ( y , F ( x ) )}{\partial F ( x )} ]}_{F ( x ) = {F}_{m} ( x )} .$$

Since the problem involved in the present disclosure is a multi-objective black-box optimization problem where gradient information of the problem is not available, to address this issue, the present disclosure trains a Kriging model to establish an approximate function for the black-box optimization problem, and then the gradient of the problem is calculated using the above formula.

The loss function adopts the common L₂ approach, which calculates the square of a difference between a predicted value and a true value. The specific calculation formula is as follows:

$$L ( y , {F}_{m} ( x ) ) = \frac{1}{2} {( y - {F}_{m} ( x ) )}^{2} .$$

A decision tree is used to construct the sub-model function −gₘ(x) of the (m+1)-th iteration as a target variable to be predicted (in the case of the L₂ loss function, a new target variable is a residual between the latest prediction function and the original target variable). Once a new decision tree model is obtained, predicted values for all data are assumed to be h(x). Therefore, after the (m+1)-th iteration, the overall prediction function should be:

$${F}_{m + 1} ( x ) = {F}_{m} ( x ) + {β}_{m + 1} h ( x ) .$$

βₘ₊₁ represents a step size for each iteration, where an optimal step size for each iteration can be found using the method of least squares.

Based on the principle of the gradient boosted neural network algorithm, the implementation process can be broken down into the following steps:
1. Select a training dataset that is used by all relevant models, with each data point in the dataset assigned an equal weight; and select a base model algorithm.
2. Use the base model to make an initial prediction on training data.
3. Assign a different weight to each data point in the dataset based on prediction errors of the initial prediction, with higher weights assigned to points with larger errors.
4. Iterate this process, where the model is continuously trained on the dataset with adjusted weights, and a new model obtained each time correct misjudgments made by a previous model.
5. A final model result is a weighted combination of all models, resulting in a more ideal outcome.

In each iteration, a negative gradient of the current model across all samples is calculated first. Then, a new weak classifier for fitting is trained with the negative gradient as the objective, and the weight of the weak classifier is calculated, to ultimately update the model.

Based on the above content, this embodiment provides a multi-objective optimization method assisted by a gradient boosted neural network. As shown in FIG. 2, the method includes the following steps:
Step 100: Obtain sample data of an energy control management system of a hybrid electric vehicle through design of experiments (DOE). The sample data includes at least a maximum threshold range of a battery state of charge when an internal combustion engine 102 is turned off, a minimum threshold range of the battery state of charge when the internal combustion engine 102 is turned on, a minimum speed range for operating the internal combustion engine 102, a maximum speed range for operating the internal combustion engine 102, a torque value range of the internal combustion engine 102, and a speed range at which the internal combustion engine 102 is turned off.
Step 200: Determine an approximate function for a multi-objective optimization problem of the energy control management system based on a gradient boosted neural network algorithm. Objectives in the multi-objective optimization problem are: battery stress, operation changes, emission, noise, and battery state of charge.
Step 300: Solve the approximate function by using a multi-objective optimization algorithm to obtain an optimal solution.
Step 400: Control the internal combustion engine 102 according to the optimal solution by an power control system 101 of the energy control management system.

Design of Experiments (DOE) is a statistical-based experimental design method, for example a method for uniform sampling, such as random sampling, Latin hypercube sampling, low-discrepancy sequence sampling, etc. Specifically, in this embodiment, Latin hypercube sampling is used as the uniform sampling method. Alternatively, any other DOE can also be used as sampling methods.

In a preferred implementation, step 100 is specifically as follows:

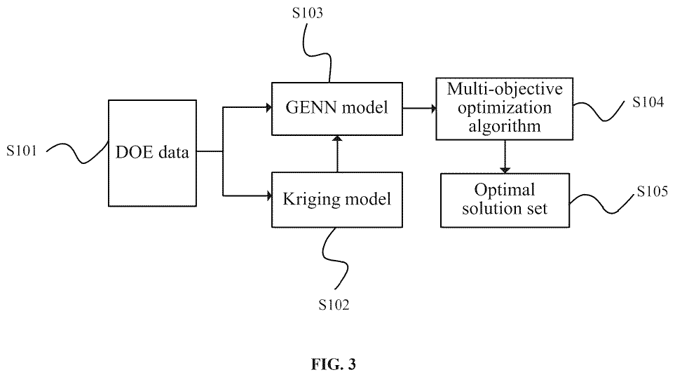

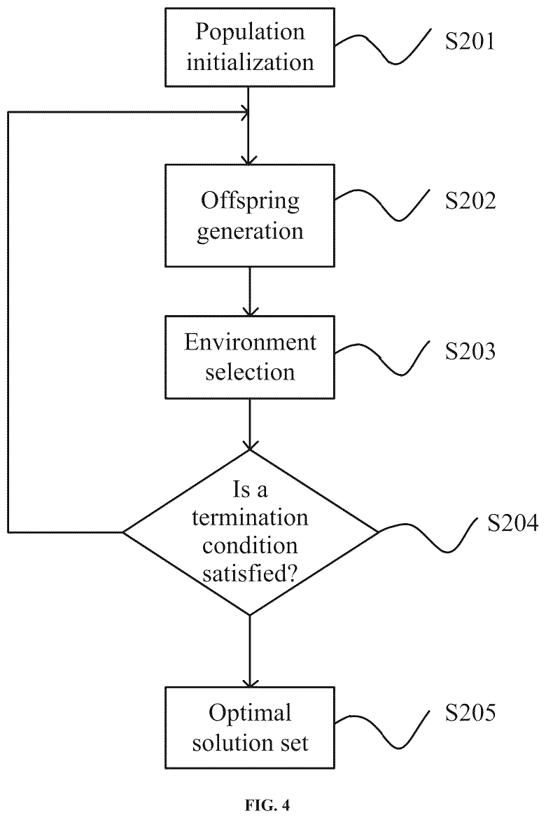

The framework of the method provided in this embodiment, as shown in FIG. 3, involves obtaining sample data through Design of Experiments (DOE) for model training in S102 and S103.

As a preferred implementation, step 200 specifically includes: training the gradient boosted neural network based on the sample data and a Kriging model to obtain the approximate function for the multi-objective optimization problem.

To obtain gradient information for the problem, the Kriging model is trained to establish an approximate analytical expression for the multi-objective optimization problem, which is then used for calculating the gradient in the gradient boosted neural network in S103. S102 is merely a specific example of the overall algorithm process and is not limited to the Kriging model; other methods can also be used to obtain the gradient information. In the present disclosure, the Kriging model is first used to approximate the function to obtain gradient information, which is then incorporated into the gradient neural network for the final function fitting.

A GENN model is trained based on the sample data from S101 and the Kriging model from S102, and an approximate function of the multi-objective optimization problem is obtained, for solution set evaluation in S104.

As a preferred implementation, step 300 specifically includes: solving the approximate function by using a multi-objective optimization algorithm NSGA-II, to obtain the optimal solution.

The optimal solution is optimal values for the maximum threshold of the battery state of charge when the internal combustion engine 102 is turned off, the minimum threshold of the battery state of charge when the internal combustion engine 102 is turned on, the minimum speed for operating the internal combustion engine 102, the maximum speed for operating the internal combustion engine 102, the speeds of the internal combustion engine 102 in the first operation to the third operation, the torque values of the internal combustion engine 102 in the first operation to third operation, and the speed at which the internal combustion engine 102 is turned off.

In this embodiment, the existing classical and widely used multi-objective optimization algorithm NSGA-II is employed to handle the multi-objective optimization problem fitted in step 300, where other multi-objective optimization algorithms are also suitable to be embedded into the overall algorithm process.

Following the general process of multi-objective optimization algorithms, the implementation process of NSGA-II is illustrated in FIG. 4.
S201: Initialize a population based on constraints of an optimization problem and upper and lower bounds of the problem. Specifically, N individuals that satisfy the constraints are randomly generated initially, with N set to 100.
S202: Generate offspring. Specifically, parent individuals are selected using a tournament selection method. The tournament selection method is a form of local competitive selection where k individuals are randomly selected from the population for comparison. For a minimization multi-objective optimization problem, individuals with smaller fitness function values are selected to enter the parent population. This process is repeated N times until the parent population reaches the required size. Then, polynomial crossover and mutation operations are performed to generate new offspring.
S203: Select an environment. Specifically, the generated offspring and parents (200 individuals) are combined, and 100 excellent individuals are selected. The selection method involves non-dominated sorting, followed by calculating a crowding distance for each non-Pareto-dominant layer. Individuals with larger crowding distances are prioritized for retention.
S204: Check whether a termination condition is met. Specifically, the termination condition is the number of cyclic iterations of the population.
S205: Output a optimal solution.

In step S400, the working state of internal combustion engine 102 can be controlled by an power control system 101 of the energy control management system according to the optimal solution.

In some embodiments, the power control system 101 can execute the operation of turning off the internal combustion engine 102 according to the optimal solution. For example, if the current vehicle speed is lower than the optimal value of a speed V_{off} at which the internal combustion engine 102 is turned off, the internal combustion engine 102 is turned off; if the battery state of charge is greater than the optimal value of SOCₘₐₓ, the internal combustion engine 102 is turned off; if the battery state of charge is less than the optimal value of SOCₘᵢₙ, the internal combustion engine 102 is turned on.

In some embodiments, the power control system 101 may execute the following operations according to the optimal solution: when the internal combustion engine 102 is on and the speed is lower than the optimal value of the minimum speed V₁ for operating the internal combustion engine 102, the first operation is executed; when the internal combustion engine 102 is on and the speed is between the optimal value of minimum speed V₁ for operating the internal combustion engine 102 and the optimal value of maximum speed V₂ for operating the internal combustion engine 102, the second operation is executed; and when the internal combustion engine 102 is on and its speed is greater than the optimal value of maximum speed V₂ for operating the internal combustion engine 102, the third operation is executed. During the first operation, the internal combustion engine 102 operates in the condition of optimal values of Rev₁ and Torque₁. During the second operation, the internal combustion engine 102 operates in the condition of optimal values of Rev₂ and Torque₂. During the third operation, the internal combustion engine 102 operates in the condition of optimal values of Rev₃ and Torque₃. Furthermore, the power control system 101 can execute predetermined operations according to the optimal solution, which correspond to the minimum speed, maximum speed, and torque values of the internal combustion engine 102. This enables the internal combustion engine 102 and electric motor 104 to operate in a working state that conforms to each other's physical work characteristics, thereby improves energy efficiency, reduces noise during vehicle operation, lowers emissions, and reduces battery load.

### Embodiment 2

In order to perform the method in Embodiment 1 to achieve corresponding functions and technical effects, a multi-objective optimization system assisted by a gradient boosted neural network is provided below.

This embodiment provides a multi-objective optimization system assisted by a gradient boosted neural network, including:
a data obtaining module configured to obtain sample data of an energy control management system of a hybrid electric vehicle through design of experiments;
an approximate function determining module configured to determine an approximate function for a multi-objective optimization problem of the energy control management system based on a gradient boosted neural network algorithm; and
an optimization solving module configured to solve the approximate function by using a multi-objective optimization algorithm to obtain an optimal solution.

### Embodiment 3

This embodiment of the present disclosure provides an electronic device, including a memory and a processor, where the memory is configured to store a computer program, and the processor runs the computer program to enable the electronic device to execute the multi-objective optimization method assisted by a gradient boosted neural network in Embodiment 1.

Optionally, the electronic device may be a server.

In addition, an embodiment of the present disclosure further provides a computer readable storage medium storing a computer program. The computer program is executed by a processor to implement the multi-objective optimization method assisted by a gradient boosted neural network in Embodiment 1.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

1. A multi-objective optimization method assisted by a gradient boosted neural network, comprising:
obtaining sample data of an energy control management system of a hybrid electric vehicle through design of experiments, wherein the sample data comprises at least a maximum threshold range of a battery state of charge when an internal combustion engine is turned off, a minimum threshold range of the battery state of charge when the internal combustion engine is turned on, a minimum speed range for operating the internal combustion engine, a maximum speed range for operating the internal combustion engine, a speed range of the internal combustion engine, a torque value range of the internal combustion engine, and a speed range at which the internal combustion engine is turned off;
determining an approximate function for a multi-objective optimization problem of the energy control management system based on a gradient boosted neural network algorithm;
solving the approximate function by using a multi-objective optimization algorithm to obtain an optimal solution, wherein the optimal solution comprises at least optimal values of: a maximum threshold of the battery state of charge when the internal combustion engine is turned off, a minimum threshold of the battery state of charge when the internal combustion engine is turned on, a minimum speed for operating the internal combustion engine, a maximum speed for operating the internal combustion engine, a speed of the internal combustion engine, a torque value of the internal combustion engine, and a speed at which the internal combustion engine is turned off; and
controlling the internal combustion engine according to the optimal solution by an power control system of the energy control management system.

2. (canceled)

3. The multi-objective optimization method assisted by a gradient boosted neural network according to claim 1, wherein objectives in the multi-objective optimization problem are: battery stress, operation changes, emission, noise, and battery state of charge.

4. The multi-objective optimization method assisted by a gradient boosted neural network according to claim 1, wherein said determining the approximate function for the multi-objective optimization problem of the energy control management system based on the gradient boosted neural network algorithm comprises:
training the gradient boosted neural network based on the sample data and a Kriging model to obtain the approximate function for the multi-objective optimization problem.

5. The multi-objective optimization method assisted by a gradient boosted neural network according to claim 1, wherein said solving the approximate function by using the multi-objective optimization algorithm to obtain the optimal solution comprises:
solving the approximate function by using a Non-dominated Sorting Genetic Algorithm II (NSGA-II), to obtain the optimal solution.

6. A multi-objective optimization system assisted by a gradient boosted neural network, comprising:
a data obtaining module obtains sample data of an energy control management system of a hybrid electric vehicle through design of experiments, wherein the sample data comprises at least a maximum threshold range of a battery state of charge when an internal combustion engine is turned off, a minimum threshold range of the battery state of charge when the internal combustion engine is turned on, a minimum speed range for operating the internal combustion engine, a maximum speed range for operating the internal combustion engine, a speed range of the internal combustion engine, a torque value range of the internal combustion engine, and a speed range at which the internal combustion engine is turned off;
an approximate function determining determines an approximate function for a multi-objective optimization problem of the energy control management system based on a gradient boosted neural network algorithm; and
an optimization solving module solves the approximate function by using a multi-objective optimization algorithm to obtain an optimal solution, wherein the optimal solution comprises at least optimal values for a maximum threshold of the battery state of charge when the internal combustion engine is turned off, a minimum threshold of the battery state of charge when the internal combustion engine is turned on, a minimum speed for operating the internal combustion engine, a maximum speed for operating the internal combustion engine, a speed of the internal combustion engine, a torque value of the internal combustion engine, and a speed at which the internal combustion engine is turned off; and
wherein an power control system of the energy control management system control the internal combustion engine according to the optimal solution.

7. An electronic device, comprising a memory and a processor, wherein the memory is configured to store a computer program, and the processor runs the computer program to enable the electronic device to perform the multi-objective optimization method assisted by a gradient boosted neural network according to claim 1.

8. The electronic device according to claim 7, wherein the sample data includes at least one selected from a group consisting of a maximum threshold range of a battery state of charge when an internal combustion engine is turned off, a minimum threshold range of the battery state of charge when the internal combustion engine is turned off, a minimum speed range for operating the internal combustion engine, a maximum speed range for operating the internal combustion engine, a torque value range of the internal combustion engine, and a speed range at which the internal combustion engine is turned off.

9. The electronic device according to claim 7, wherein objectives in the multi-objective optimization problem are battery stress, operation changes, emission, noise, and battery state of charge.

10. The electronic device according to claim 7, wherein said determining the approximate function for the multi-objective optimization problem of the energy control management system based on the gradient boosted neural network algorithm comprises:
training the gradient boosted neural network based on the sample data and a Kriging model to obtain the approximate function for the multi-objective optimization problem.

11. The electronic device according to claim 7, wherein said solving the approximate function by using the multi-objective optimization algorithm to obtain the optimal solution comprises:
solving the approximate function by using a Non-dominated Sorting Genetic Algorithm II (NSGA-II), to obtain the optimal solution.
